(19) United States
(12) Patent Application Publication
(10) Pub. No.: US 2008/0025835 A1
(43) Pub. Date: Jan. 31, 2008

(54) Bernoulli wand

(76) Inventor: Juha Paul Liljeroos, Keihasrinne (FI)

Correspondence Address: KNOBBE, MARTENS, OLSEN & BEAR LLP, 2040 MAIN STREET, FOURTEENTH FLOOR, IRVINE, CA, 92614, US

(21) Appl. No.: 11/497,060

(22) Filed: Jul. 31, 2006

(51) Int. Cl. B65G 67/16

(52) U.S. Cl. 414/804

(57) ABSTRACT

A Bernoulli wand for transporting thin (e.g., 200 mm) semiconductor wafers between a rack and a hot process chamber. The wand has a head portion that is configured to cover the entire wafer. The head has a plurality of gas outlets configured to produce a flow of gas along an upper surface of a wafer to create a pressure differential between the upper surface of the wafer and the lower surface of the wafer. The pressure differential generates a lift force that supports the wafer below the head portion of the wand in a substantially non-contacting manner, employing the Bernoulli principle.

### FIELD OF THE INVENTION

The present invention relates to semiconductor substrate handling systems and, in particular, relates to semiconductor substrate pickup devices employing gas flow to lift a substrate using the Bernoulli effect.

### BACKGROUND AND SUMMARY

Integrated circuits are typically comprised of many semiconductor devices, such as transistors and diodes, which are formed on a thin slice of semiconductor material, known as a wafer. Some of the processes used in the manufacturing of semiconductor devices in the wafer involve positioning the wafer in high temperature chambers where the wafer is exposed to high temperature gases, which result in layers being formed on the wafer. When forming such integrated circuits, it is often necessary to load the wafer into and remove it from a high temperature chamber where the wafer can reach a temperature as high as 1200 degrees Celsius. An example of such a high temperature process is epitaxial chemical vapor deposition, although the skilled artisan will readily appreciate other examples of processing at greater than, e.g., 400° C. However, since the wafer is extremely brittle, and vulnerable to particulate contamination, great care must be taken so as to avoid physically damaging the wafer while it is being transported, especially when the wafer is in a heated state.

To avoid damaging the wafer during the transport process, various wafer pickup devices have been developed. The particular application or environment from which the wafer is lifted often determines the most effective type of pickup device. One class of pickup devices, known as Bernoulli wands, is especially well suited for transporting very hot wafers. Bernoulli wands formed of quartz are especially advantageous for transporting wafers between high temperature chambers since metal designs cannot withstand such high temperatures and/or can contaminate wafers at such elevated temperatures. The advantage provided by the Bernoulli wand is that the hot wafer generally does not contact the pickup wand, except perhaps at one or more small locators positioned outside the wafer edge on the underside of the wand, thereby minimizing contact damage to the wafer caused by the wand. Bernoulli wands for high temperature wafer handling are disclosed in U.S. Pat. No. 5,080,549 to Goodwin et al. and in U.S. Pat. No. 6,242,718 to Ferro et al., the entire disclosures of which are hereby incorporated herein by reference. The Bernoulli wand is typically mounted at the front end of a robot or wafer handling arm.

In particular, when positioned above the wafer, the Bernoulli wand uses jets of gas to create a gas flow pattern above the wafer that causes the pressure immediately above the wafer to be less than the pressure immediately below the wafer. Consequently, the pressure imbalance causes the wafer to experience an upward “lift” force. Moreover, as the wafer is drawn upward toward the wand, the same jets that produce the lift force produce an increasingly larger repulsive force that prevents the wafer from contacting the Bernoulli wand. As a result, it is possible to suspend the wafer below the wand in a substantially non-contacting manner.

A typical quartz Bernoulli wand design for transporting 200 mm wafers and smaller in high temperature processes is shown in FIG. 1A. The Bernoulli wand is preferably formed of quartz, which is advantageous for transporting very hot wafers. As shown in FIG. 1A, the Bernoulli wand 10 has truncated sides 12 such that the Bernoulli wand 10 can load and unload wafers from a cassette rack for holding multiple wafers in a multi-wafer processing apparatus.

FIG. 1B is a plan view of the flat head portion 14 of the Bernoulli wand 10 between shelves 16 of a cassette rack. A typical cassette rack 8 with individual slots 17 is shown in FIG. 1C. Each slot 17 is capable of holding a wafer 20. Typically, these cassette racks 16 hold about 26 200 mm wafers in a vertical column. As shown in FIG. 1B, the truncated sides 12 allow the Bernoulli wand 10 to be inserted between the shelves 16 of a cassette rack. When loaded into a slot 17 (FIG. 1C) of the cassette rack 8, opposite peripheral edges (which are left “uncovered” by the truncated sides 12) of a wafer 20, shown by dotted line 20 in FIG. 1B, are horizontally supported by the shelves 16 of the cassette rack 8 while the Bernoulli wand 10 is inserted between the shelves 16. The Bernoulli wand 10 having the truncated sides 12 is configured such that it can fit between the shelves 16, thereby allowing for a fairly densely stacked cassette rack 8.

During loading into a hot process chamber, and especially onto the hot surface of a susceptor, a wafer will typically become distorted because the lower part of the wafer heats up more quickly than the upper part, as is well known in the art. This uneven heating creates a temporary distortion of the wafer referred to as “curl” or “curling”. Curl is particularly problematic in a process chamber having a temperature over 400 degrees Celsius. This curl effect can occur very rapidly when a room temperature wafer is being placed on a hot substrate holder, such as a susceptor. If rapid enough, the effect can make the wafer jump on contact and can move the wafer away from its desired position on the susceptor.

The tendency to curl derives from temperature gradients generated in the wafer during pick-up and drop-off and also depends on the type of wafer being processed. Wafer curl is a problem, particularly with very thin wafers. Typically, the thinner the wafer, the more likely it will curl due to different coefficients of thermal expansion in conjunction with temperature gradients. Similarly, silicon-on-insulator (SOI) wafers, which are two wafers bonded together, have a tendency to curl. Some heavily doped substrates, which tend to have a higher stress level, are more prone to curl when the substrate contacts a hot surface, such as a susceptor. Also, as discussed above, very high temperature differences between a wafer and the support structure onto which the wafer is dropped will cause curl.

The design shown in FIGS. 1A-1C has been found particularly problematic. Due to the open sides that facilitate use with cassettes, it has been found that the front side of a curling wafer, where active devices are formed, can be scratched by the truncated sides 12 of the Bernoulli wand 10 if the wafer curl is severe enough to cause contact between the wafer and wand 10. It has also been determined that the truncated sides 12 of the wand 10 also promote the degree of curl by increasing the temperature differential across the wafer as a result of allowing the wafer area under the truncated portion to have direct radiation applied to it. The portions of the wafer under the non-truncated portion of the Bernoulli wand 10 act to filter some of the radiation to the wafer.

In accordance with one embodiment of the invention, a wafer handling device is provided, comprising a high temperature substantially transparent head portion and an elongated high temperature neck. The head portion is configured to transport a 200 mm in diameter or smaller wafer, and has at least one gas outlet arranged to direct gas flow against the wafer in a manner to support the wafer using a Bernoulli effect. The head portion is configured to be positioned over the entire wafer. The elongated neck has a first end and a second end, and is configured to be connected to a robotic arm on the first end and to the head portion on the second end. The head portion and the neck are in fluid communication.

In accordance with another embodiment of the invention, a semiconductor processing tool is provided, comprising a rack having a plurality of vertically stacked wafer slots, a high temperature substantially transparent wafer handling device, and a process chamber. The wafer handling device has a head portion configured to support a wafer in a substantially non-contacting manner from above and the head portion is configured to be positioned over substantially the entire wafer. The wafer handling device is configured to access the wafer in the rack and transport the wafer to the process chamber.

In accordance with yet another embodiment of the invention, a method is provided for transporting a semiconductor wafer. A head portion of a Bernoulli wand is positioned over an entire upper surface of the wafer having a diameter of 200 mm or less. The head portion is formed of a material for high temperature processing. The wafer is drawn toward the head portion by creating a low pressure zone over the upper surface of the wafer, and the wafer is transported in a substantially non-contacting manner while supporting the wafer with the low pressure zone.

### BRIEF DESCRIPTION OF THE DRAWINGS

These and other aspects of the invention will be readily apparent to the skilled artisan in view of the description below, the appended claims, and from the drawings, which are intended to illustrate and not to limit the invention, and wherein:

FIG. 1A is a schematic plan view of a Bernoulli wand.

FIG. 1B is a schematic top plan view of the flat head portion of the Bernoulli wand of FIG. 1A between shelves of a cassette.

FIG. 1C is a schematic top and front perspective view of a cassette rack.

FIG. 2A schematically illustrates a wafer transport system comprised of a Bernoulli wand that is configured to engage with a semiconductor wafer, according to an embodiment.

FIG. 2B is a schematic top plan view of the Bernoulli wand of FIG. 2A.

FIG. 2C is a cross-sectional view of an angled gas outlet hole in the lower plate of the head of the Bernoulli wand of FIG. 2A.

FIG. 2D is a side view of the head of a Bernoulli wand, according to another embodiment.

FIG. 2E is a schematic diagram of a semiconductor processing system including a Bernoulli wand.

### DETAILED DESCRIPTION OF THE PREFERRED EMBODIMENT

The following detailed description of the preferred embodiments and methods presents a description of certain specific embodiments to assist in understanding the claims. However, one may practice the present invention in a multitude of different embodiments and methods as defined and covered by the claims.

Referring more specifically to the drawings for illustrative purposes, the present invention is embodied in the devices generally shown in the Figures. It will be appreciated that the apparatuses may vary as to configuration and as to details of the parts, and that the methods may vary as to the specific steps and sequence, without departing from the basic concepts as disclosed herein.

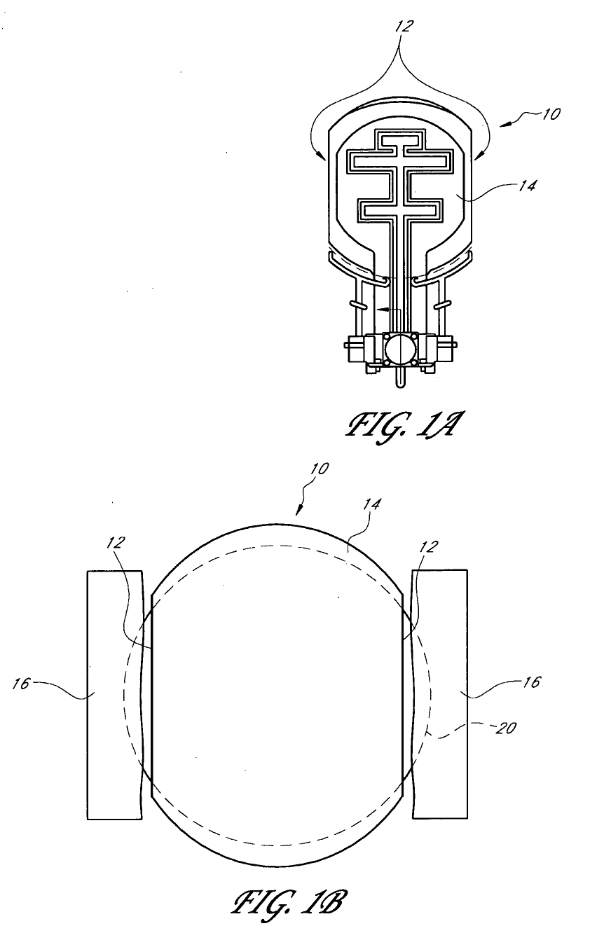

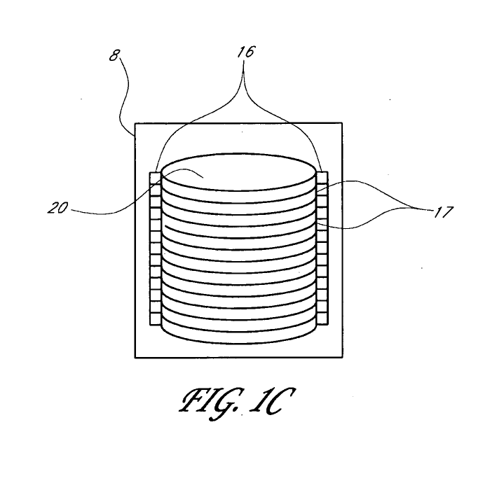

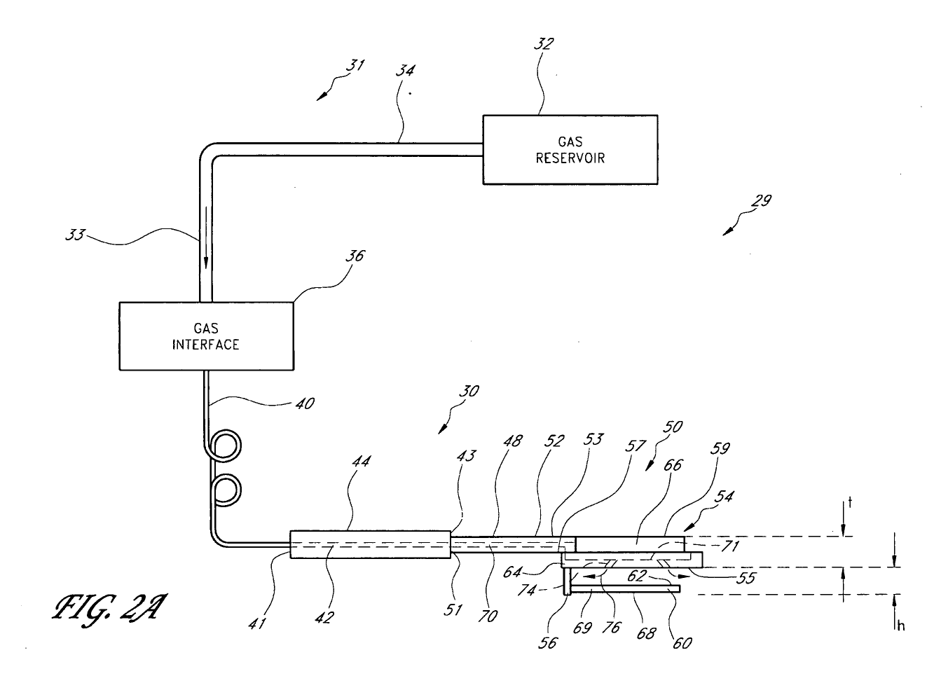

The improved wafer transport system described hereinbelow includes a modified Bernoulli wand made of a transparent material for high temperature processing that minimizes the curling problem associated with the wands described above, especially in ultra-thin 200 mm or smaller wafers. Suitable transparent high-temperature materials include, but are not limited to, quartz, glass, and ceramics. Such Bernoulli wands can withstand temperatures in a range from room temperature to about 1150° C., and more preferably in a range from about 400-900° C., and even more preferably in a range from about 300-500° C. The skilled artisan will understand that ultra thin wafers typically have a thickness of about 250-300 μm. Typically, there is an “open area” (where the sides are truncated as discussed above) in the Bernoulli wand that allows direct heat energy transfer between the wafer and the surrounding space. Direct heating or cooling of the wafer occurs through this “open area” in the Bernoulli wand, thereby contributing to the unwanted curling effect. The curling effect is even more problematic because the truncated sides 12 of a typical high temperature 200 mm Bernoulli wand 10 can allow contact and scratch the front side of a wafer. The potential damage to the wafer due to scratching is minimized by modifying the wand so that it covers the whole area of the thin wafer during loading and unloading from the hot process chamber. As it covers the whole area of the wafer, the modified wand does not have the truncated sides of the Bernoulli wand shown in FIGS. 1A and 1B.

The wafer transport mechanism described herein may be used in an epitaxial deposition system, but it can also be used in other types of semiconductor processing systems. The skilled artisan will understand that as the modified wand does not have truncated sides, it is preferably used to access wafers in a rack having shelf spacing or pitch greater than or equal to 0.375 inch, as will be explained in more detail below.

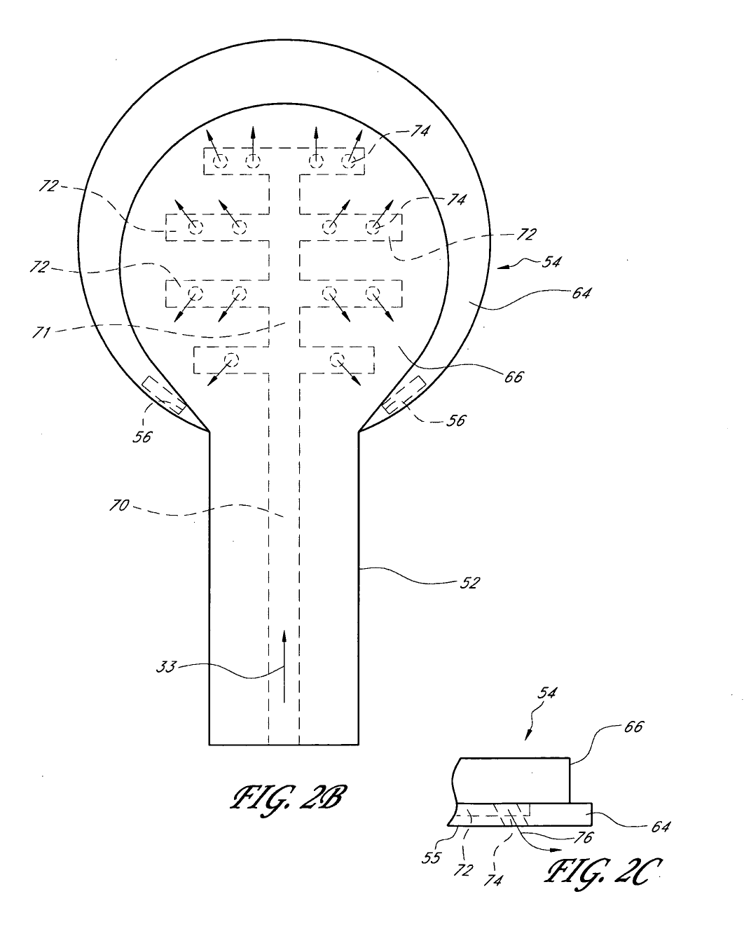

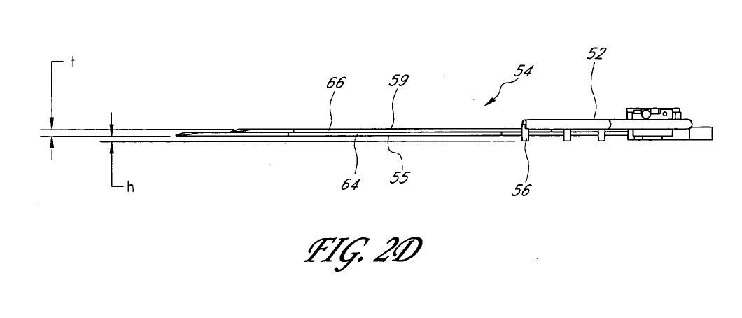

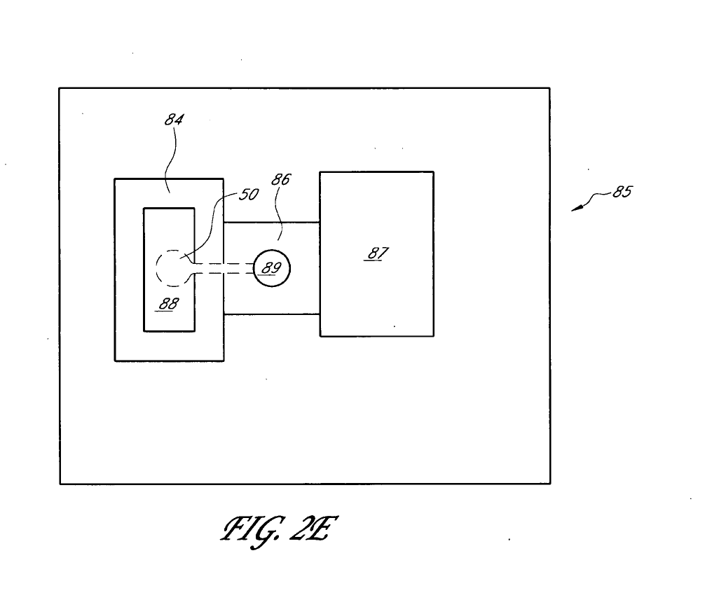

Reference will now be made to the drawings wherein like numerals refer to like parts throughout. FIG. 2A schematically illustrates an embodiment of a semiconductor wafer transport system 29 that is adapted to transport a substantially flat semiconductor wafer 60 into and out of a high temperature chamber. In particular, the system 29 comprises a wafer transport assembly 30 having a movable Bernoulli wand 50 that is configured to engage with a wafer 60, preferably a 200 mm wafer or smaller, for transport in a substantially non-contacting manner. The system 29 further comprises a gas supply assembly 31 that is adapted to supply a flow of inert gas 33, such as nitrogen (N₂), to the wand 50. It will be understood that the Bernoulli wand 50 is typically mounted on a robot, as other end effectors are in the semiconductor processing field.

As shown in FIG. 2A, the gas supply assembly 31 typically comprises a main gas reservoir 32 and a main gas conduit 34 connected thereto. In particular, the reservoir 32 preferably includes an enclosed cavity that is adapted to store a large quantity of gas under a relatively high pressure and a pressure regulator to controllably deliver the flow of gas 33 through the conduit 34 for an extended period of time. Alternatively, a pressurized gas supply may be used in place of a gas reservoir.

As shown in FIG. 2A, the wafer transport assembly 30 comprises a gas interface 36, a conduit 40, a robotic arm 44 having a proximal or rear end 41, a movable distal or front end 43, and an enclosed gas channel 42 extending therebetween. In particular, the gas interface 36 is adapted to couple with the main gas conduit 34 of the gas supply assembly 31 so as to enable the gas 33 to flow into the robotic arm 44. Moreover, the front end 43 of the robotic arm 44 is adapted to be controllably positioned so as to displace the Bernoulli wand 50 connected thereto in a controlled manner.

As shown in FIG. 2A, the Bernoulli wand 50 includes an elongated neck or rear portion 52, a forward portion or flat head 54, and a plurality of alignment feet 56. The neck 52 includes a first end 51 and a second end 53, an upper surface 48, and an enclosed central gas channel 70 that extends from the first end 51 to the second end 53. Furthermore, the first end 51 of the neck 52 is attached to the front end 43 of the robotic arm 44 to allow the gas 33 to flow from the channel 42 in the robotic arm 44 into the central gas channel 70 in the neck portion 52 of the Bernoulli wand 50. Additionally, the second end 53 of the neck portion 52 of the Bernoulli wand 50 is attached to the head 54 of the wand 50 to physically support the head 54 and to allow the gas 33 to flow from the central gas channel 70 into the head 54.

As indicated schematically in FIG. 2A, the head 54 is formed of a substantially flat upper plate 66 and a substantially flat lower plate 64 that are combined in a parallel manner to form a composite structure having a first end 57, a lower surface 55, and an upper surface 59. The head 54 is sized and shaped to cover the entire area of the wafer, as shown in FIG. 2B. In a preferred embodiment, the head 54 is substantially circular, without truncated sides, and is preferably configured for transporting a wafer having a diameter of 200 mm or less. The diameter of the head 54 is preferably about the same as the diameter of the wafer. For example, the head 54 of a wand 50 configured to transport a 200 mm wafer preferably has a diameter of about 200 mm. In some embodiments, the head 54 may have a diameter larger or smaller than the diameter of the wafer. The skilled artisan will appreciate that a head 54 that is too large may interfere with the interface between the head 54 and a rack or cassette, whereas a head 54 that is too small may not provide an adequate Bernoulli effect. Thus, the diameter of the head 54 is preferably within ±5 mm of the diameter of the wafer, and more preferably within ±2 mm of the diameter of the wafer. In some embodiments, the head 54 is not perfectly circular and the diameter along one axis may be greater than the diameter along another axis. The head 54 has a thickness “t” (FIGS. 2A and 2D) preferably of about ⅛-⅜ inch in thickness, and more preferably about 0.120 inch in thickness. In a preferred embodiment, each plate 64, 66 is about 0.060 inch thick.

Because the entire area of the wafer is covered by the head 54, the problem of wafer curl, as described above, is minimized because there are no truncated sides resulting in an “open area” in the Bernoulli wand that allows direct heat energy transfer between the wafer and the surrounding space above (e.g., heat lamps positioned above the wand and wafer). The Bernoulli wand, although transparent, acts as a filter for certain frequencies of light. Thus, because there are no truncated sides, there is no direct heating or cooling of the wafer occurring through an “open area,” thereby minimizing the unwanted curling effect, during pick-up and drop-off of the wafer while transporting to and from a hot process chamber. A wand having the truncated sides provides no filter at all in the “open area” and the direct heating through the “open area” accentuates the curling action. The circular design of the head provides a homogeneous gas flow, preferably of nitrogen, to the entire upper surface of the wafer, thereby minimizing curl and allowing processing of thinner wafers at higher temperatures.

Furthermore, since the neck 52, head 54, and feet 56 of the wand 50 are preferably constructed of a high temperature transparent material, such as, for example, quartz, the Bernoulli wand 50 is preferably able to extend into a high temperature chamber to manipulate the wafer 60 having a temperature as high as 1150° C., and more preferably in a range of about 400-900° C., and even more preferably in a range of about 300-500° C., while minimizing damage to the wafer 60. The use of such high temperature materials enables the wand 50 to be used to pick up relatively hot substrates without contaminating the substrates.

Furthermore, the head 54 is supported by and in fluid communication with the neck 52. The head 54 is further adapted to permit the gas 33 to flow to a plurality of gas outlet holes 74 (FIG. 2B) that are located on the lower surface 55 (FIG. 2A) of the head 54, as will be described below. As shown in FIG. 2B, the head 54 further includes an enclosed central gas channel 71 and a plurality of enclosed side channels 72 that extend laterally from the channel 71, wherein the central channel 71 and each of the side channels 72 are formed as grooves in the upper surface of the lower plate 64 of the head 54, as shown in FIG. 2B. Alternatively, the central channel 71 and the plurality of channels may be formed in the lower surface of the upper plate 66. Furthermore, each of the side channels 72 extends from the central channel 71 to allow the gas 33 to flow from the central channel 71 to each of the side channels 72. Moreover, the head 54 is further comprised of the plurality of angled distributed gas outlet holes 74 that extend through the lower plate 64 from the side channels 72 to the lower surface 55 (FIG. 2A) of the head 54 so as to produce a gas flow 76 therefrom having a generally radial pattern outward over the wafer, as shown in FIGS. 2A and 2C. The skilled artisan will understand that the pattern of the angled gas flow results in the Bernoulli effect.

When the wand 50 is positioned above the wafer 60 having a flat upper surface 62 and a flat lower surface 68, the wafer 60 becomes engaged with the wand 50 in a substantially non-contacting manner, as shown in FIG. 2A. In particular, as shown in FIG. 2A, the gas flow 76 shoots horizontally and radially across the upper surface 62 of the wafer 60 from above, creating a low pressure zone over the wafer 60 where the pressure above the wafer is less than the pressure below the wafer. Thus, in accordance with the Bernoulli effect, the wafer 60 experiences an upward “lift” force and is drawn toward the head portion 54.

The upward force causes the wafer 60 to be subsequently displaced to an equilibrium position, wherein the wafer 60 levitates below the head 54 substantially without contacting the head 54. In particular, at the equilibrium position, the downward reactive force acting on the wafer 60 caused by the gas flow 76 impinging the upper surface 62 of the wafer 60 and the gravitational force acting on the wafer 60 combine to offset the lift force. Consequently, the wafer 60 levitates below the head 54 at a substantially fixed position with respect to the head 54. Furthermore, while the wafer 60 is engaged by the head 54 in the foregoing manner, the plane of the wafer 60 is oriented to be substantially parallel to the plane of the head 54. Moreover, the distance between the upper surface 62 of the wafer 60 and the lower surface 55 of the head 54 is typically small in comparison with the diameter of the wafer 60. This distance is preferably in the range of about 0.008-0.013 inch.

To prevent the wafer 60 from moving in a horizontal manner, the holes 74 are distributed and angled to impart a lateral bias to the gas flow 76 that causes the wafer 60 to gently travel toward the feet 56 of the wand 50. According to an embodiment, the feet have a height “h” (FIG. 2D) of about 0.08 inch from the lower surface 55 of the wand 50. Consequently, a non-sensitive edge surface 69 of the wafer 60 subsequently engages with the feet 56 to prevent further lateral movement of the wafer 60 with respect to the wand 50, as shown in FIG. 2A.

The skilled artisan will understand that the feet may be positioned on either end of the head 54 to prevent further lateral movement of the wafer 60 with respect to the wand 50. In some embodiments, as shown in FIGS. 2A, 2B, and 2D, the feet 56 are positioned at the proximal end of the head 54. In other embodiments, the feet are positioned at the distal end of the head. It will be understood that if the wand 50 is used with a rack, such as a cassette, the feet 56 are preferably positioned at the proximal end of the head 54, as illustrated in FIGS. 2A, 2B, and 2D. The skilled artisan will appreciate that the feet may be positioned at the distal end of the head if the wand 50 is not used with a rack. The feet 56 are preferably also formed of high temperature material, such as quartz.

One embodiment of a semiconductor processing system 85 is illustrated in FIG. 2E. FIG. 2E is a schematic overhead diagram showing a section of the semiconductor processing system 85. A load port or a loadlock chamber 84 is preferably joined with a wafer handling chamber (WHC) 86, as shown in FIG. 2E. In the illustrated embodiment, the Bernoulli wand 50 is connected to a WHC robot 89 that resides within the WHC 86. The Bernoulli wand 50 is configured to access wafers within a rack or cassette 88 configured to hold 200 mm wafers for transport from the load port or loadlock chamber 84 to a process chamber 87, where a wafer may be processed on a susceptor, in accordance with this embodiment. Preferably, the rack 88 within the loadlock chamber 84 has greater vertical spacing between slots than a standard 200 mm wafer cassette 8 (FIG. 1C). Accordingly, the Bernoulli wand 50 can reach into the slots for loading and unloading wafers.

The skilled artisan will understand that, in other embodiments, there may be a plurality of process chambers 87 and/or loadlock chambers 84 adjacent to the WHC 86 and the WHC robot 89 and Bernoulli wand 50 may be positioned to have effective access to the interiors of all of the individual process chambers and cooling stations without the need to interact with a rack. In such a system, a separate end effector (e.g., a paddle) can be provided to interact with a rack. The process chambers 87 may be used to perform the same process on wafers. Alternatively, as the skilled artisan will appreciate, the process chambers 87 may each perform a different process on the wafers. The processes include, but are not limited to, sputtering, chemical vapor deposition (CVD), etching, ashing oxidation, ion implantation, lithography, diffusion, and the like. Each process chamber 87 typically contains a susceptor, or other substrate support, for supporting a wafer to be treated within the process chamber 87. The process chamber 87 may be furnished with a connection to a vacuum pump, a process gas injection mechanism, and exhaust and heating mechanisms.

The rack 88 can be a portable cassette or a fixed rack, with a wafer capacity, preferably between about 10 and 20, and more preferably between about 12 and 14, within the loadlock chamber 84. The skilled artisan will understand that, in embodiments where the Bernoulli wand 50 interacts with the loadlock chamber 84, the cassette or rack 88 should have slots configured less densely (having an increased pitch compared to standard cassettes) such that the distance between each wafer stacked in the rack 88 is greater than the distance between wafers in a rack configured to be used with a Bernoulli wand 10 having the configuration with truncated sides 12, as shown in FIGS. 1A and 1B. The reason for a less densely (than a standard 200 mm wafer cassette 8 as shown in FIG. 1C) stacked rack 88 is that the Bernoulli wand 50 of this embodiment, having a substantially circular head 54, cannot be inserted between the shelves 16 of a standard slot 17 because the head 54 is too wide without the truncated sides 12 of the Bernoulli wand 10 shown in FIGS. 1A and 1B. Preferably, the pitch or spacing between slots in the preferred rack 88 is preferably at least about 0.1875 inch, and more preferably at least about 0.25 inch, and even more preferably about 0.375 inch. Therefore, according to this embodiment, the head 54 is preferably inserted into the rack 88 above the shelves of the slot in which the wafer is inserted such that the wafer can be supported by the shelves.

With the Bernoulli wand 50 engaging the wafer 60 in the manner described above, movement of the Bernoulli wand 50 caused by the movement of the distal end 43 of the robotic arm 44 advantageously results in virtually contact-free pick-up, movement, and drop-off of the wafer 60. Any curl resulting from this contact-free transport of the wafer 60 causes only the edges (as opposed to top or front side of wafer having active devices formed thereon) of the wafer 60 to contact the Bernoulli wand 50, if at all.

Although this invention has been disclosed in the context of certain preferred embodiments and examples, it will be understood by those skilled in the art that the present invention extends beyond the specifically disclosed embodiments to other alternative embodiments and/or uses of the invention and obvious modification thereof. Thus, it is intended that the scope of the present invention herein disclosed should not be limited by the particular disclosed embodiments described above, but should be determined only by a fair reading of the claims that follow.

What is claimed is:

1. A semiconductor wafer handling device, comprising:
a high temperature substantially transparent head portion configured to transport a wafer having a diameter of 200 mm or less, the head portion having at least one gas outlet arranged to direct gas flow against the wafer in a manner to support the wafer using the Bernoulli effect, wherein the head portion is configured to be positioned over the entire wafer; and
an elongated high temperature material transparent neck having a first end and a second end, the neck being configured to be connected to a robotic arm on the first end and to the head portion on the second end, wherein the head portion and the neck are in fluid communication.

2. The semiconductor wafer handling device of claim 1, wherein the head portion has a diameter of about 200 mm ±5 mm.

3. The semiconductor wafer handling device of claim 1, wherein the at least one gas outlet is angled to direct gas across an upper surface of the wafer and to flow outwardly to a periphery of the wafer to create a pressure above the wafer which is less than a pressure below the wafer.

4. The semiconductor wafer handling device of claim 1, wherein the neck is connected to a gas supply.

5. The semiconductor wafer handling device of claim 1, wherein the head portion is formed of quartz.

6. The semiconductor wafer handling device of claim 1, wherein the head portion is substantially circular.

7. The semiconductor wafer handling device of claim 1, wherein the head portion and the neck comprise quartz.

8. A semiconductor processing tool, comprising:
a process chamber;
a rack having a plurality of vertically stacked wafer slots; and
a high temperature substantially transparent wafer handling device having a head portion configured to support a wafer having a diameter of 200 mm or smaller in a substantially non-contacting manner from above, wherein the head portion is configured to be positioned over substantially the entire wafer, wherein the wafer handling device is configured to access the wafer in the rack and transport the wafer to the process chamber.

9. The semiconductor processing tool of claim 8, wherein a pitch of the slots is at least about 0.1875 inch.

10. The semiconductor processing tool of claim 8, wherein the rack has at least two slots.

11. The semiconductor processing tool of claim 8, wherein the wafer handling device is connected to a gas supply and configured to produce a flow of gas along an upper surface of the wafer to produce a pressure differential between an upper surface of the wafer and a lower surface of the wafer.

12. The semiconductor processing tool of claim 11, wherein the pressure differential generates a lift force that supports the wafer below the head portion of the wafer handling device.

13. The semiconductor processing tool of claim 8, wherein the wafer handling device is formed of quartz.

14. The semiconductor processing tool of claim 8, wherein the head portion includes a plurality of gas outlets.

15. The semiconductor processing tool of claim 8, further comprising a loadlock chamber and a wafer handling chamber, wherein the wafer handling chamber is connected to the loadlock chamber and the process chamber, wherein the wafer handling device is positioned within the wafer handling chamber and the rack is positioned within the loadlock chamber.

16. The semiconductor processing tool of claim 8, wherein the wafer handling device is configured to transport the wafer using the Bernoulli principle.

17. The semiconductor processing tool of claim 8, wherein the head portion is substantially flat and has a diameter of about 200 mm ±5 mm.

18. A semiconductor substrate handling device, comprising:
a quartz head portion configured to be positioned over an entire upper surface of a substrate having a diameter of 200 mm or less, wherein the head portion is configured to support the substrate by employing the Bernoulli principle; and
an elongated quartz neck portion in fluid communication with the head portion.

19. The semiconductor substrate handling device of claim 18, wherein the head portion is configured to supply gas in a manner to create a low pressure zone over the upper surface of the wafer, thereby drawing the wafer toward the head portion.

20. The semiconductor substrate handling device of claim 18, wherein the head portion is substantially circular.

21. The semiconductor substrate handling device of claim 18, wherein the head portion comprises at least one gas outlet configured to direct gas flow against the upper surface of the wafer.

22. The semiconductor substrate handling device of claim 21, wherein the at least one gas outlet is connected to at least one gas channel in the head portion.

23. A method of transporting a semiconductor wafer, comprising:
positioning a head portion of a Bernoulli wand over an entire upper surface of the wafer having a diameter of 200 mm or less, wherein the head portion is formed of a material for high temperature processing;
drawing the wafer toward the head portion by creating a low pressure zone over the upper surface of the wafer; and
transporting the wafer in a substantially non-contacting manner while supporting the wafer with the low pressure zone.

24. The method of claim 23, wherein a pressure in the low pressure zone over the wafer is lower than a pressure below the wafer.

25. The method of claim 23, wherein creating the lower pressure zone comprises flowing gas in a generally radial manner across the upper surface of the wafer.

26. The method of claim 25, wherein gas flows from gas outlet holes in a lower surface of the head portion.

27. The method of claim 26, wherein the gas outlet holes are in fluid communication with a gas supply.

28. The method of claim 23, wherein the head portion is substantially circular.

29. The method of claim 28, wherein the head portion is in fluid communication with an elongated neck portion.

30. The method of claim 23, wherein drawing the wafer comprises biasing the wafer toward feet positioned on an underside of the Bernoulli wand such that only an edge of the wafer contacts the Bernoulli wand while transporting the wafer.

31. The method of claim 23, wherein the material for high temperature processing is quartz.
